(19) United States
(12) Patent Application Publication
(10) Pub. No.: US 2003/0122082 A1
(43) Pub. Date: Jul. 3, 2003

(54) Flexible support mechanism

(76) Inventors: Larry D. Frederick, Huntsville, AL (US); Dwight Medley, Kelso, TN (US)

Correspondence Address: DICKSTEIN SHAPIRO MORIN & OSHINSKY LLP, 2101 L STREET NW, WASHINGTON, DC, 20037-1526, US

(21) Appl. No.: 10/270,148

(22) Filed: Oct. 15, 2002

Related U.S. Application Data
(63) Continuation-in-part of application No. 10/101,374, filed on Mar. 20, 2002.
(60) Provisional application No. 60/276,896, filed on Mar. 20, 2001.

(51) Int. Cl. G01T 1/20

(52) U.S. Cl. 250/361 R

(57) ABSTRACT

A flexible support mechanism for protecting an object is described. The flexible support mechanism includes at least one flexible support sleeve for providing dynamic protection to the object. One embodiment includes an inner flexible support sleeve separated from an outer flexible support sleeve by a plurality of spacers. The outer flexible support sleeve is designed to be stronger than the inner flexible support sleeve. The inner flexible support sleeve is designed to inhibit the transference of vibrations to the object, while the outer flexible support sleeve is designed to inhibit the transference of physical shock and/or high vibration to the object. For a flexible support mechanism used to protect a scintillation element, the flexible support sleeve or sleeves are formed of a material which is transparent to gamma radiation.

This is a continuation-in-part application of U.S. patent application Ser. No. 10/101,374, filed Mar. 20, 2002, which claims priority from co-pending U.S. patent application Ser. No. 09/811,781, filed Mar. 20, 2001, co-pending U.S. patent application Ser. No. 09/626,744, filed Jul. 26, 2000, co-pending U.S. patent application Ser. No. 09/471,122, filed Dec. 23, 1999, and U.S. provisional application Serial No. 60/276,896, filed Mar. 20, 2001, all of which are incorporated by reference herein in their entireties.

### BACKGROUND

The invention generally relates to a protective mechanism for use in systems for detecting the presence of rock during coal or ore mining operations or the presence of hydrocarbons during drilling operations.

Nuclear detectors, such as gamma detectors, have been used in mining applications and oil drilling operations for many years. In particular, gamma detectors have been used to measure the radiation that emanates from the formations surrounding the mining or drilling equipment. Such gamma detectors operate by utilizing the differences between the natural radioactivity of the target formation and the natural radioactivity of the adjacent formations to determine the boundaries between these formations.

For example, a coal seam is generally located between two shale rock beds. In this example, the coal exhibits a significantly lower level of natural radiation than the surrounding rock. Specifically, as the radiation passes through the coal from the rock, it is attenuated. It is this attenuation that is measured, by counting gamma rays that pass through the coal, to determine when cutting should be halted to avoid cutting into the rock. Each gamma ray produces a flash of light, or scintillation, when it penetrates a scintillation material inside a gamma detector. Counting gamma rays must be accomplished over a period of time because the nature of radiation is statistical, having an emission rate that is represented by a Gaussian distribution around some central value. Thus, a rise in the gamma count rate should signal proximity to the rock. By measuring the gamma count rate, the interface between the coal and the rock can be precisely determined. This precise determination allows the mining equipment to cut virtually the entire coal bed without cutting into the shale rock. This maximizes the coal mined while minimizing or eliminating the transporting of the rock out of the mine, the processing necessary to remove the rock from the coal, and the rock disposal cost.

Known techniques of mining for coal or ore are based on direct observations by the operator of the mining equipment. The operator knows the approximate location of the previous cut made by the mining equipment, and has a general awareness of the present location of the cutter drum. A clear view of the cutter, particularly when cutting at the floor, is not possible because the operator cannot get close enough to the cutter to see around the front of the miner and because of the dust and the water sprays. He must watch for any change in the color of the dust cloud which indicates rock penetration, and/or he listens for a change in the sound of the cutter drum. While this technique does work, it is rather imprecise and typically results in leaving a noticeable amount of coal or ore or the inclusion of a detrimental amount of rock in the coal or ore that is being mined. The most common result is to remove rock rather than to leave unmined coal. The operator is particularly challenged when making crosscuts from one room to another because his view is very limited as the miner cuts around a pillar. As a result, the mine operation must pay the high cost of removing and disposing of the rock from the coal/ore before it is sold.

In addition, the use of this manual technique requires the operator to be positioned as near to the cutter as possible, typically at the side of the miner. This is a high risk location, and numerous injuries and even deaths have resulted from working in this location. Having to be near the mineral face also significantly increases exposure to dust and noise, both of which are health hazards. Attempts to place the operator behind the miner have resulted in significant impairment of his ability to control the miner.

In mining operations, in order for a nuclear device, such as a gamma detector, to accurately detect the interface between the rock and the formation of interest (e.g. a coal bed) it must measure the distance between the tips of the picks on the cutter drum and the rock. This distance is the same as the thickness of the coal between the cutter picks and the rock. It is the thickness of the coal that can be measured by counting the gamma rays that pass through the coal. Optimal positioning of the gamma detector, therefore, is near the cutter. Only from this position is a change in the detector count rate as a function of the thickness of the coal between the cutter drum and the rock significant enough to be seen above statistical fluctuations that are inherent to all nuclear measurements. It is also important that the size of the field of view not be significantly reduced or increased by the movement of the cutter. Having the detector move along with the cutter is desirable.

Radiation is inversely proportional to distance, as exemplified by the ratio 1/r². Thus, by placing the gamma detector far back on the mining equipment and away from the cutting region, this alone significantly reduces the flux from the area near the cutter drum. In addition, the body of the mining equipment is between the detector and that region. This provides very effective shielding of the radiation that emanates from the rock near the cutter drum. These two factors combine to reduce the flux from the rock near the detector to very low levels.

Further, a detector far from the cutting region and positioned back on the mining equipment is surrounded by the rock exposed by earlier mining, and there is relatively little shielding from this exposed rock, compared to being mounted near the coal face, and in front of the miner. Thus, there will be a substantial radiation flux upon the detector from this non-target region. This results in a very low signal from the rock in front of the cutter compared with the background signal from exposed rock near the detector. After factoring in the statistical fluctuations inherent in any nuclear measurement and the relatively short sample time required by the speed of the mining operation, an unacceptably low signal to noise ratio is obtained.

The radiation flux from rock adjoining coal/ore usually originates from trace levels of radioactive potassium, uranium, or thorium that are found in the rock. While there is considerable variability in the concentration of these elements in earth formations, they are typically found in higher concentrations in the rock adjacent to mineral formations like coal than in the mineral formations themselves. Thus, the radiation level for bare rock is usually significantly higher than the radiation level in the middle of the vein of coal/ore. In an homogenous earth formation, an equilibrium radiation spectrum is seen. In a typical case, a discrete spectrum of gamma rays are produced by the radioactive decay of the trace elements mentioned above. These gamma rays are transported through the formation, losing energy through Compton scattering (and possibly pair production), until they are finally photoelectrically absorbed. The high energy regions of the radiation flux are not replenished, because the natural radioactivity of coal is much lower than that of the rock. As coal is removed and thereby is reduced in thickness, the gamma rays shift to sufficiently high energies so that absorption becomes a less significant factor.

One aspect of measuring the radiation from rock is the variety in the coal/ore and in the rock above or below the coal/ore. There are differing forms of rock that may be above or below a mineral vein. A typical coal formation, for example, might have fire clay under the coal and marine shale above the coal. In addition, at places, iron sulfide rocks or other materials may be in the vein, most often protruding down from the marine shale above the vein. A layer of shale may be located within the vein. The thickness of the rock may also vary. Further, the amount of released radiation varies, even within a mine. Sometimes, the radiation in one part of the formation, such as the roof, may be many times more intense than another part, such as the floor.

In addition, the mining process itself adds variability. The speed of the mining equipment will vary from cut to cut. The attitude of the mining equipment may change as a result of depth variations in previous cuts. During mining, a coal or rock pile is produced between the cutter drum and the body of the boom. This pile may vary in size, in density, and in elemental composition. These factors and others have prevented simplistic methods of mechanizing the cutting.

As explained above, the natural gamma count rate increases as the coal is removed and the distribution of the counts within various energy bands changes accordingly. The thickness of the remaining coal and the distance from the tips of cutter picks on the cutter and the rock is the same dimension. If the incremental movement of the cutter picks relative to the rock that is emitting the radiation can be accurately determined, then the changes in the gamma count rates can be correlated with those incremental changes in position. Through modeling and empirical data, the shape of a curve generated by this correlation can be used to more accurately calculate the thickness of the coal yet to be cut.

Attempts have been made to locate known gamma detectors on the cutting boom near the cutting region without success. See U.S. Pat. Nos. 3,591,235 (Addison), 4,262,964 (Ingle et al.), and 5,496,093 (Barlow). The area near the cutter is a very hostile environment for nuclear detectors. In this location, the detector package is subjected to the outflow from the cutter, resulting in massive shocks and high abrasion. Gamma detectors are sensitive and must be protected from harsh environments to survive and to produce accurate, noise free signals. This protection must include protection from physical shock and stress, including force, vibration, and abrasion, encountered during mining operations. However, the closer in proximity the gamma detector is to the mineral being mined, the greater is the shock, vibration and stress to which the detector is subjected. Thus, there is a tension between placing conventional gamma detectors close to the surface being mined to make accurate measurements and providing adequate protection to ensure survival of the sensor and to avoid degradation of the data by the effects of the harsh environment. Conventionally, the need to assure survival of the sensor has resulted in placement of the sensor away from the target of interest.

Accumulation of rock and coal debris on the miner in the vicinity of the detector adds uncertainty to the measurement in addition to the previously discussed factors. The detector requires both shielding and windows to have an adequate signal to noise ratio. Any detection system in a mining environment must first satisfy mine safety requirements by being placed in an explosion-proof container. The detector package must fit in the very limited available space. The detector itself must be of a minimum size, or else it will not have a counting rate that is sufficiently large to enable the signal to be statistically significant.

As a result of the severe environment near the material to be cut, gamma detectors have typically been located farther back on the mining equipment. Since this location is much more benign, and since there is typically more room available farther back on the mining equipment, it is far simpler to design a detector package for this location instead of close to the boom.

However, while a location farther back on the mining equipment simplifies the design process, it also degrades the performance of the detector, as previously explained. Even with an optimized window/shielding design, the signal from the region of the miner will be significantly smaller than the background from the exposed rock. This low signal to noise ratio, combined with the statistical uncertainty inherent in a nuclear measurement, has rendered known gamma detectors virtually worthless as a means of controlling the cutter.

Another conventional approach has been to make gamma detectors smaller so that they can be more easily placed in a strategically desirable location. However, the sensitivity of a smaller detector drops as the size is reduced, and again, the accuracy decreases in a corresponding fashion.

One method of mining coal/ore is continuous mining, in which tunnels are bored through the earth with a machine including a cutting drum attached to a movable boom. The operator of a continuous mining machine must control the mining machine with an obstructed view of the coal/ore being mined. This is because the operator is situated at a distance from the cuts made by the picks on the cutting drum and his view is obstructed by portions of the mining machine as well as dust created in the mining operation and water sprays provided by the miner. Another method of mining coal/ore is longwall mining, which also involves the use of two cutting drums, each attached to a boom called a ranging arm. In longwall mining, as compared with continuous mining, the drums cut a swath of earth up to one thousand feet at a time. Another method of mining coal is high wall mining. To accomplish this method using an unmanned mining machine, such as a continuous miner, the machine is operated by remote control. Typically, the operator relies upon video cameras and vibration sensors to control the cutting. Continuous mining machines, longwall mining machines, and high wall mining machines are used in very harsh conditions. The power supplies, amplifiers, processors, and other electronics are made fully safe by being enclosed within an explosion-proof housing.

Space for installing a gamma detector on a continuous miner is very limited since the detector must be positioned in a specific location in order to be in view of the coal to rock interface. The presence of armor, which is required to protect the detector, further limits the available space. An explosion-proof housing takes up even more of the available space, and often results in reducing the diameter of the photomultiplier tube. As the diameter of the photomultiplier tube is reduced, the efficient transfer of light to the tube becomes more critical. The optical coupling thus must be as thin as possible while remaining durable. Dynamic support elements must be very effective in protecting the detector from the harsh vibrations and shock but must also do so while consuming a small amount of space. Similarly, the outer portions of the detector, the armor, must provide a high level of shielding from unwanted radiation and must protect the detector from impact and abrasion, all with a minimal use of space.

### SUMMARY

The inventions provide a gamma detector which, in some aspects, may be utilized in mining applications, and in other aspects in oil well drilling and/or servicing operations. In one aspect of the inventions, the gamma detector includes a scintillation element, a housing or shield encompassing the scintillation element, and at least one flexible support sleeve.

The invention provides a scintillation element package that includes a scintillation element, a shield encompassing the scintillation element, and a flexible support sleeve at least partially surrounding the scintillation element within the shield, the flexible support sleeve providing dynamic support for the scintillation element.

The invention also provides, in one aspect, a flexible support mechanism that includes a flexible support sleeve surrounding and protecting an object to be protected, wherein the flexible support sleeve provides dynamic support for the object. In another aspect, the invention provides a flexible support mechanism including an inner flexible support sleeve surrounding and protecting an object to be protected and an outer flexible support sleeve surrounding the inner flexible support sleeve, the outer flexible support sleeve fitting within a cavity. The flexible support sleeves provide dynamic support for the object.

One aspect of the invention provides a gamma detector including a scintillation element, an inner flexible support sleeve surrounding the scintillation element, and an outer flexible support sleeve surrounding the inner flexible support sleeve, wherein the outer flexible support sleeve fits within a cavity and wherein the flexible support sleeves provide dynamic support for the scintillation element.

Another aspect of the invention provides a gamma detector that includes a photomultiplier tube and a flexible support sleeve at least partially surrounding and providing dynamic support for the photomultiplier tube.

These and other objects, advantages and features will be more readily understood from the following detailed description of preferred embodiments of the invention which is provided in connection with the accompanying drawings.

### BRIEF DESCRIPTION OF THE DRAWINGS

FIG. 1 is a side view of a gamma detector constructed in accordance with an embodiment of the invention.

FIG. 2 is a top view of the gamma detector of FIG. 1.

FIG. 3 is a cross-sectional view taken along line III-III of FIG. 2.

FIG. 4 is a cross-sectional view taken along line IV-IV of FIG. 2.

FIG. 5 is a cross-sectional view taken along line V-V of FIG. 2.

FIG. 6 is a cross-sectional view of a flexible support mechanism constructed in accordance with another embodiment of the invention.

FIG. 7 is an enlarged view of the circle VII of FIG. 6.

FIG. 8 is a graph illustrating the ratio of acceleration experienced by an object to the acceleration being induced upon the object for a ten gravity sine sweep over a variety of frequencies.

FIG. 9 is a graph illustrating the ratio of acceleration experienced by an object to the acceleration being induced upon the object for a thirty gravity sine sweep over a variety of frequencies.

### DETAILED DESCRIPTION OF PREFERRED EMBODIMENTS

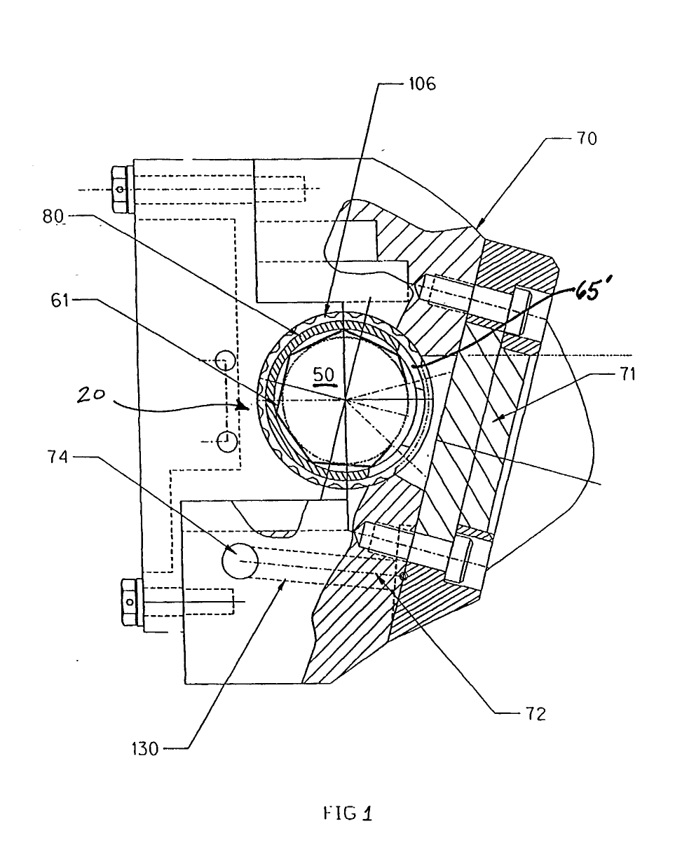

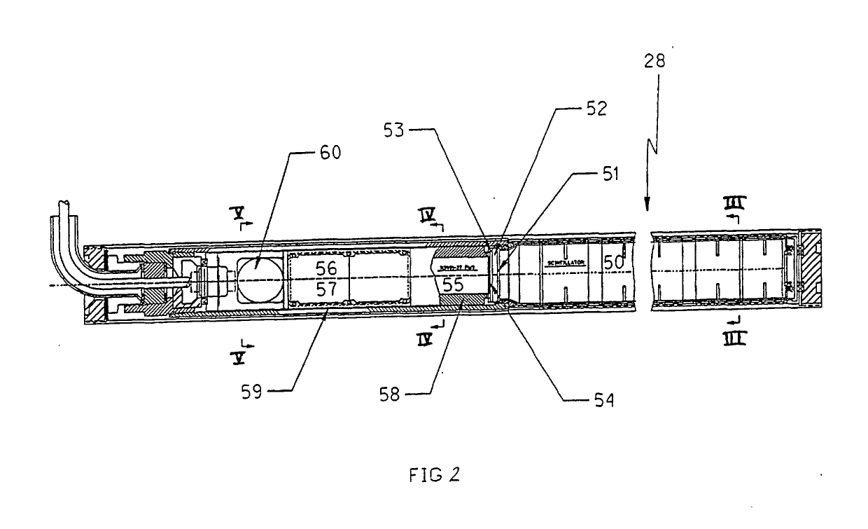

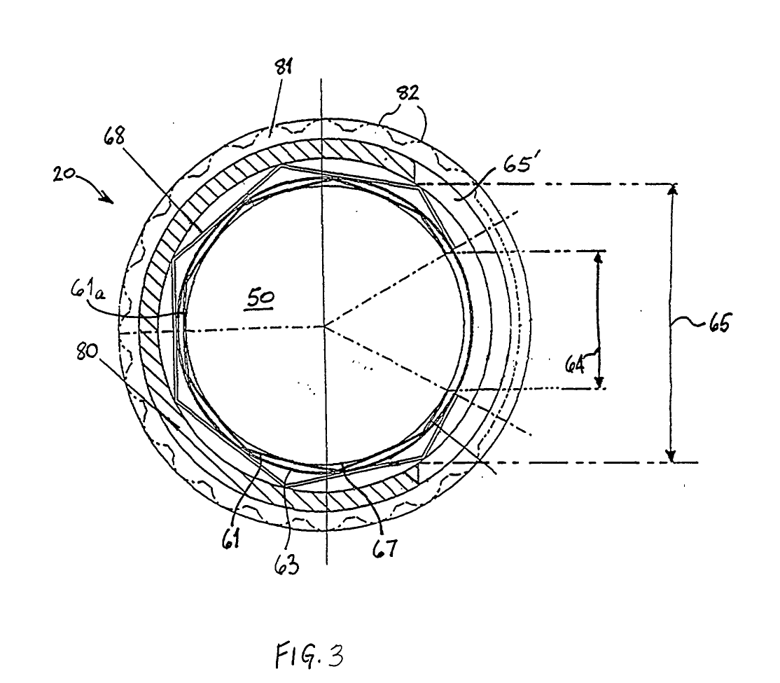

FIG. 1 illustrates a gamma detector 20 installed into a mining machine, although the gamma detector 20 also may be used in conjunction with oilfield operations. Many functional elements are required to make effective the rock detectors 20, 120. As shown in FIG. 1, the rock detector 20 is protected by armor 70 that surrounds, shields, and supports them at a critical location near the cutter picks of the mining machine cutting drum. FIGS. 3-5, which are cross-sectional views of FIG. 2, show the various elements that protect the scintillation element 50, the electronics 57 and other sensors. These multiple levels of protection are described in detail below.

Gamma rays 28 entering the gamma detector 20 pass through a non-metallic window 71 to reach the scintillation element 50 within the rock detector 20. Other windows 65 (FIG. 3) have been cut into a rigid dynamic enclosure 80 which surrounds the scintillation element 50. A gap 65′ is provided in a flexible support sleeve 68 within the rigid dynamic enclosure 80 and a gap 64 is provided in the flexible support sleeve 61 surrounding the scintillation element 50, inside the scintillation shield 63. The gaps 65′, 64 are aligned to minimize the amount of metal in the path of the gamma rays 28, except for the scintillation shield 63, which has been made as thin as possible.

Next, with reference to FIG. 2, will be described the general functioning of the detector 20. For purposes of the description, the detector 20 will be described in use with mining equipment. A scintillation element 50 responds to gamma rays 28 that have been emitted from the rock 26 above or below unmined coal. The response is to produce a tiny pulse of light that travels to a window 52 at the window end of the scintillation element 50 or is reflected into the window 52 by a reflector 67 (FIG. 3) that is wrapped around the scintillation element 50. The light pulse travels through an optical coupler 51, through the window 52, and through a second optical coupler 53 into the faceplate of a light detecting element, shown here as a photo-multiplier tube 55. An electrical pulse is generated by the photo-multiplier tube 55 and sent to electronics element 57. The photo-multiplier tube 55, the electronics element 57 and an accelerometer 60 are located in an assembly called a photo-metric module 58. Since components within the photo-metric module 58 utilize electricity, it is necessary that it be enclosed in an explosion-proof housing 59 to avoid accidental ignition of gas or dust that may be in the vicinity of the continuous miner 10 on which the armored rock detector 20, 120 is installed. In addition to satisfying the explosion-proof safety requirements of the Mine Safety and Health Administration, the explosion-proof housing 59 also serves as an effective barrier that protects the electrical elements 56, 57 and the accelerometer 60 from the strong electromagnetic fields generated by the heavy electrical equipment on the miner 10.

Better details of the protective elements are shown in FIGS. 3-5. The first view in FIG. 3 shows a flexible support sleeve 61 surrounding the scintillation element 50, which protects it from high levels of lower frequency vibrations. The tight fitting sleeve 61, in spring compression between the scintillation element 50 and the scintillation shield 63, firmly and uniformly supports the fragile scintillation element 50 at flat portions 61ₐ of the sleeve 61 and provides a high resonant frequency so that it will not resonate with lower frequency vibrations that pass through the outer support system. The outer support system consists of the flexible support sleeve 68 inside of the rigid enclosure 80 and a rigid elastomeric shock absorbing sheath 81 which surrounds the enclosure 80. A typical size scintillation element 50 for this application is 1.4 inches in diameter by 10 inches in length, but may be as large as 2 inches in diameter. The resonant frequency of these outer support elements 68, 81, 80 protect against shock and isolate the scintillation element 50 from high frequencies.

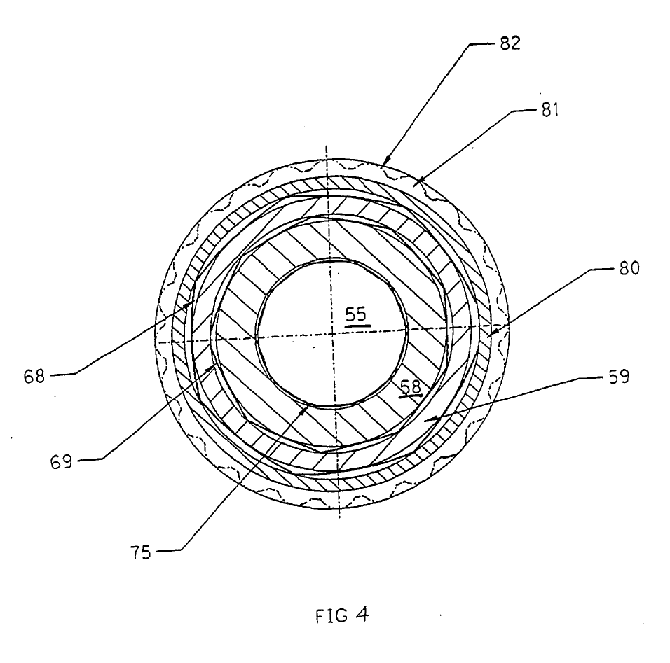

FIG. 4 illustrates a view of a photo-metric module including a photo-multiplier tube 55, which is inside a first housing 58, which in turn is within the explosion-proof housing 59. A flexible support sleeve 75 surrounds the photo-multiplier tube 55, another flexible sleeve 69 surrounds the first housing 58, and the flexible sleeve 68 extends the full length of the rigid dynamic enclosure 80 over the explosion-proof housing 59. Likewise, the elastomeric shock-absorbing sheath 81 fully covers the entire rigid dynamic enclosure 80. It should be noted that this sheath 81 serves other useful purposes. It provides good mechanical compliance with the armor 70. This is particularly important during installation in which dust and particles will be present. Another purpose of the sheath 81 is to prevent water or dust from entering through the window in the enclosure 80.

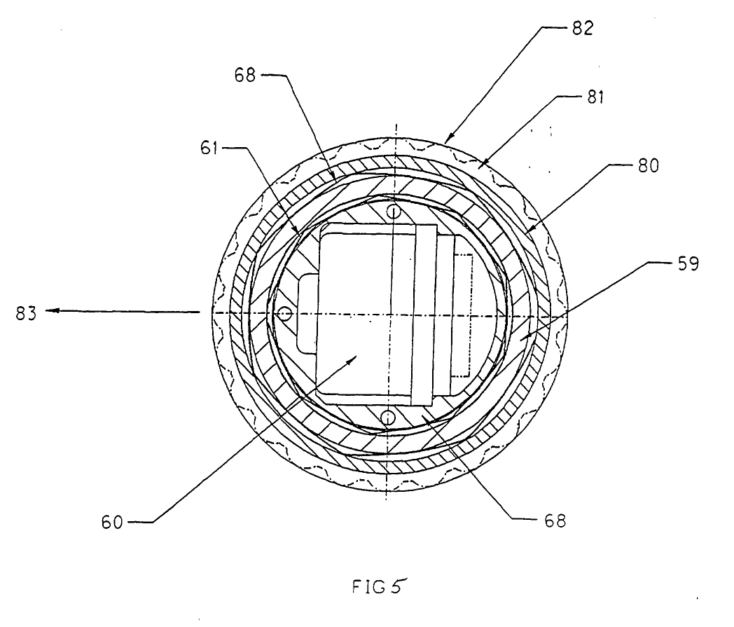

FIG. 5 illustrates the accelerometer module 60, which is afforded the same critical protection from the harsh environment as the photo-multiplier tube 55. Installation of the rock detector 20 into the armor 70 includes rotating the detector so that an axis of sensitivity 83 of the accelerometer 60 is approximately parallel with the floor plane of the miner 10, defined by the surface upon which the miner 10 crawler travels. This alignment does not have to be exact since the primary objective is to provide incremental motion information, not absolute orientation or position. It is the use of this incremental motion information by the rock detector 20, 120 that assists the geosteering concept to be effective by enabling faster and more accurate cutting decisions required to stay within the coal vein. This is better explained below.

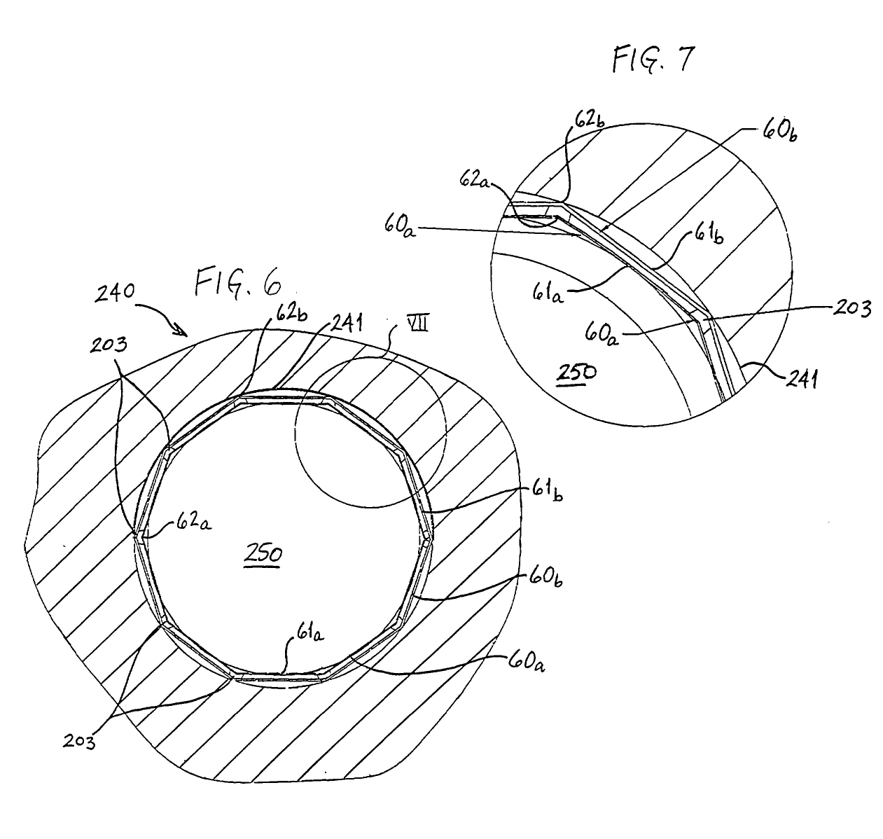

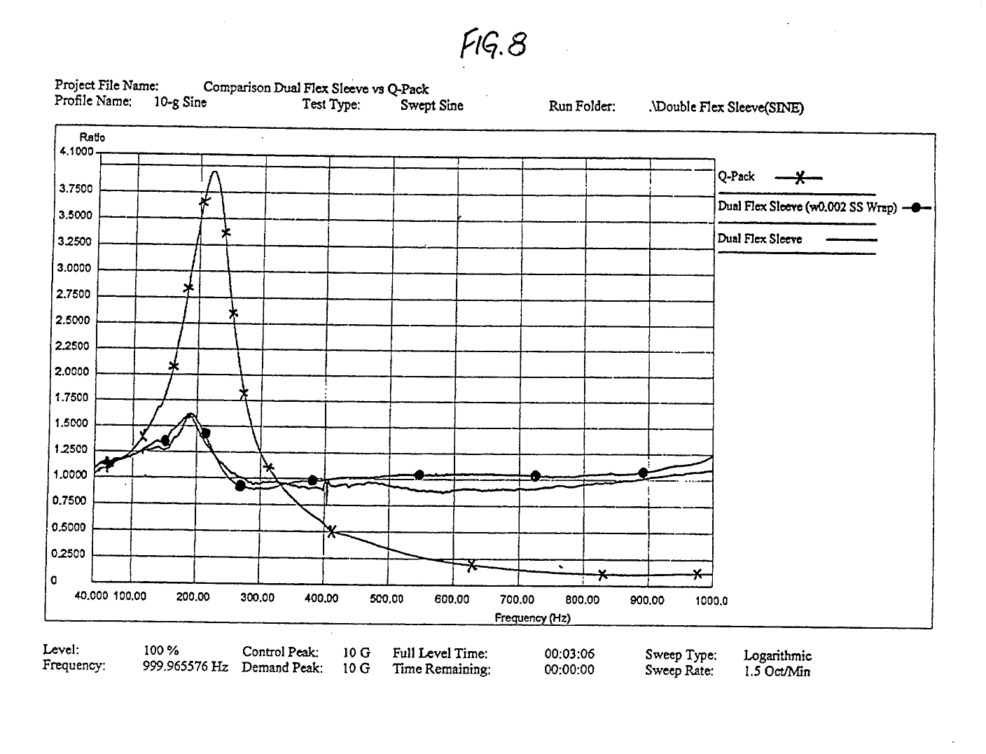

FIGS. 6 and 7 illustrate another embodiment of the invention. Specifically, a flexible support mechanism 240 is shown having an inner flexible support sleeve 60ₐ and an outer flexible support sleeve 60_{b} that surround a cylindrical object 250 and support the object within a cylindrical cavity 241. The cylindrical object 250 may be a scintillation element, such as the element 54, or a photomultiplier tube such as the tube 70, or any cylindrical object which may be subjected to and requires protection from vibration and/or physical shock.

The flexible support sleeves 60ₐ, 60_{b} each include bends and flat portions like the flexible support sleeves 60 described above. Specifically, the inner flexible support sleeve 60ₐ includes flat portions 61ₐ and bends 62ₐ, while the outer flexible support sleeve 60_{b} includes flat portions 61_{b} and bends 62_{b}. The side of the flat portions 61ₐ of the inner flexible support sleeve 60ₐ contacting the object 250 may be coated with a dry lubricant, for decreasing friction, or other materials for increasing the durability of the flexible support sleeve 60ₐ or for increasing friction. If the object 250 is a scintillation element, a shield such as shield 63 may be positioned inside of the flexible support sleeves or outside the flexible support sleeves. As illustrated, the flat portions 61_{b} of the outer flexible support sleeve 61_{b} are parallel to and align with the flat portions 61ₐ of the inner flexible support sleeve 60ₐ. The flexible support sleeves 60ₐ, 60_{b} should be formed of a material which is transparent to gamma radiation, or other materials, such as stainless steel, which exhibit spring characteristics. A preferred spring material for some flexible support sleeve applications is 17-7Ph, a specialized form of stainless steel.

Spacers or separators 203 are positioned between the flexible support sleeves 60ₐ, 60_{b}. The spacers 203 are bonded to the inner flexible support sleeve 60ₐ and are movable with respect to the outer flexible support sleeve 60_{b}. Thus, friction occurs between the spacers 203 and the outer flexible support sleeve 60_{b} upon relative movement therebetween. It should be appreciated, however, that the spacers 203 may instead be bonded to the outer flexible support sleeve 60_{b}, and hence the sliding friction occurs between the spacers 203 and the inner flexible support sleeve 60ₐ. Sliding friction also occurs between the object being protected (or the shield 63) and the inner flexible support sleeve 60ₐ, as well as between the outer flexible support sleeve 60_{b} and an outer housing. Sliding friction is useful in minimizing amplification near resonance by providing effective damping.

One application for the flexible support mechanism 240 is as a protecting structure for rock detectors, such as the rock detectors 40, 140. Rock detectors experience both high vibration and physical shock in use. Protecting against one, say for example high vibration, does not necessarily mean that the rock detector is properly protected against physical shock as well. In the illustrated flexible support mechanism 240, externally generated vibration exerts a force on the mechanism, causing relative movement between the object 250 and the flat portions 61ₐ of the inner flexible support sleeve 60ₐ, causing friction therebetween. The inner flexible support sleeve 60ₐ is tuned to have a low resonant frequency as compared to the outer flexible support sleeve 60_{b}. The resonant frequency is dependent upon the stiffness of the inner flexible support sleeve 60ₐ. Lower stiffness results in lower frequency. By properly selecting the design parameters, the resonant frequency can be chosen to be within a desirable frequency range. Sliding friction at the resonant frequency minimizes amplification at resonance. Frequencies well above resonance are then isolated away from the object being supported. In this manner, the inner flexible support sleeve 60ₐ is designed to provide the object 250 primary protection against high vibrations.

The outer flexible support sleeve 60_{b}, which is constructed to be stiffer than the inner flexible support sleeve 60ₐ, is positioned to protect the object 250 from physical shock and/or high vibration. The physical separation of the outer flexible support sleeve 60_{b} from the inner flexible support sleeve 60ₐ and the object 250 effectively limits the transmission of most vibrations except through the frictional interfaces. However, if only one inner sleeve, having a relatively low stiffness, were used, very high vibrations or high shock would cause the inner flexible support sleeve 60ₐ to deform to the extent that the object 250 would bump into the cavity surface. For very high vibrations, such as above 30 G, or for shocks above 100 G, the inner flexible support sleeve 60ₐ will be driven into the stiffer outer flexible support sleeve 60_{b} which is stiff enough to restrain the object. Even where the stiffer outer flexible support sleeve 60_{b} is being employed during high vibrations and shock, the frictional forces effectively dampen motion.

The combination of the inner and outer flexible support sleeves 60ₐ, 60_{b} provides dynamic support to the object 250 and protection against both high vibrations and physical shock, thereby lessening the noise generated by the object 250 if the object 250 is a gamma detector or another instrument so effected. Specifically, externally generated force causes relative movement between the outer flexible support sleeve 60_{b} and the wall of the cavity 241. Also, externally generated force causes relative movement between the outer flexible support sleeve 60_{b} and the inner flexible support sleeve 60ₐ. Any externally generated force will be able to transfer from the outer flexible support sleeve 60_{b} to the inner flexible support sleeve 60ₐ only through the bends 62_{b} and the spacers 203. If the vibration amplitude is low to moderately high, the motion obtained would not be sufficient to drive the inner flexible support sleeve 60ₐ into the outer flexible support sleeve 60_{b}. The outer flexible support sleeve 60_{b} contributes only in adding an additional avenue for slipping friction. If, however, a high vibration amplitude or shock is experienced, then the inner flexible support sleeve 60ₐ may be driven into the outer flexible support sleeve 60_{b}.

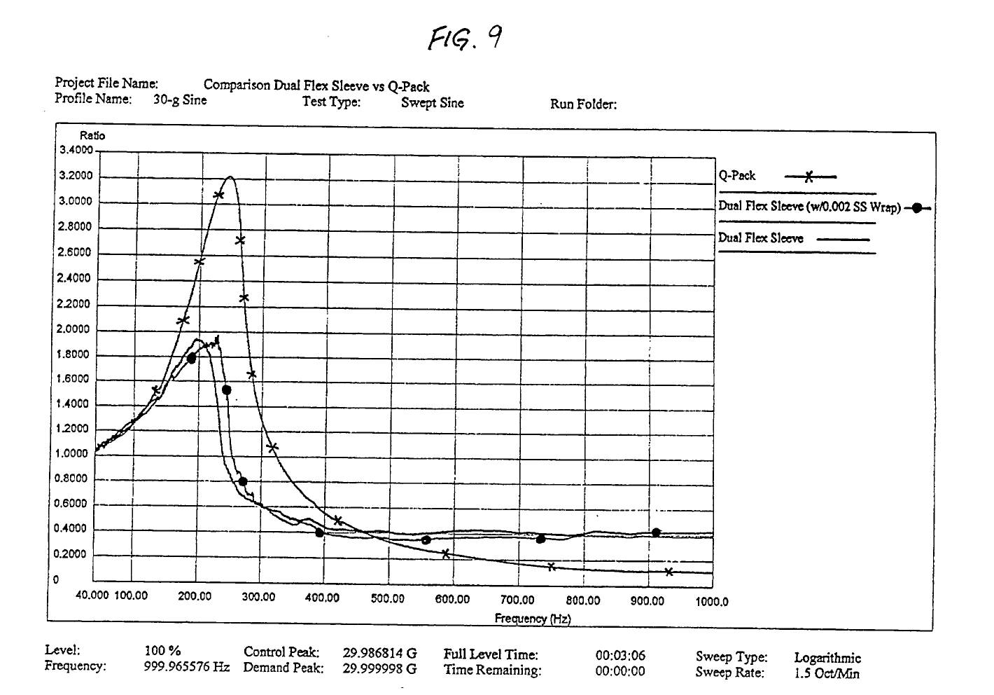

Referring now to FIGS. 8 and 9, there is shown test results comparing the capabilities of the flexible support mechanism and a conventional support mechanism to dampen destructive energy. FIG. 8 illustrates the test results of a ten times gravity sine sweep on the same object 250, protected first by a conventional elastomer Rhodia V-242 potting material, but is representative of other elastomeric materials, such as Stycast 5952, O-rings, or foam rubber wraps, second by the flexible support mechanism 240, and a third by being wrapped in 0.002 inches of stainless steel and then protected by the flexible support mechanism 240. The graph plots the ratio of the amount of acceleration the object 250 experiences to the amount of acceleration being induced on the object 250 (Y-axis) versus frequency (X-axis). Any plotted value below the ratio 1.0000 on the Y-axis is an indication that the object 250 is experiencing less acceleration, or destructive energy, than the amount of acceleration (destructive energy) being induced on the object 250. As is shown in FIG. 8, the maximum destructive energy experienced by the object 250 protected by the elastomer is approximately 39.5 gravities. The maximum destructive energy experienced by the objects 250 protected by the flexible support mechanism 240 and by the stainless steel and the flexible support mechanism 240 is approximately 16 gravities. These test results indicate that the flexible support mechanism 240 is more efficient than the conventional elastomer at dampening relatively low (10 g) but consistent vibrational energy.

FIG. 9 is a graph, like FIG. 8, showing the test results from a thirty times gravity sine sweep on the same object 250 protected similarly as in FIG. 8. Here, the results indicate that the maximum destructive energy experienced by the object 250 protected by the elastomer is approximately 96 gravities, while the maximum destructive energy experienced by the objects 250 protected by the flexible support mechanism 240 a is approximately 57 gravities. Further, FIG. 9 shows that the ratio (Y-axis) drops below 1.0000 in the 30 g test at about 250 Hz and hovers around 0.4000 at about 400 Hz and higher. FIG. 8 shows that the ratio (Y-axis) hovers around the 1.0000 level in the 10 g test at 250 Hz and higher. What these two tests indicate is that as the level of destructive energy induced on the object 250 protected by the flexible support mechanism 240 increases, the flexible support mechanism 240 becomes more efficient at dampening that destructive energy.

While the invention has been described in detail in connection with preferred embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, although the embodiments shown in FIGS. 1-7 indicate at least one flexible support sleeve that includes flat portions and bends, it should be appreciated that flexible support sleeves without discrete flat portions and bends may be used, such as, for example, flexible support sleeves with rounded portions and curved portions or any other configuration that would provide the necessary dynamic tuning for protecting the scintillation element or other package. Furthermore, while the concentric flexible support sleeves 60ₐ and 60_{b} are shown such that respective bends 62ₐ are directly opposite respective bends 62_{b}, separated by a spacer 203, instead the bends 62ₐ, 62_{b} may be offset such that one or more bends 62ₐ may contact with one or more flat portions 61_{b}. For example, one or both of the flexible support sleeves may have slits provided therein to allow the flexible support sleeves to cross each other. Accordingly, the invention is not to be seen as limited by the foregoing description, but is only limited by the scope of the appended claims.

What is claimed as new and desired to be protected by Letters Patent of the United States is:

1. A scintillation element package, comprising:
a scintillation element;
a shield encompassing said scintillation element; and
a flexible support sleeve supporting and at least partially surrounding said scintillation element, wherein said flexible support sleeve touches and extends longitudinally along the length of said scintillation element and wherein said flexible support sleeve is in spring compression between said scintillation element and said shield.

2. The package of claim 1, wherein said flexible support sleeve is formed of a spring material.

3. The package of claim 2, wherein said spring material comprises stainless steel.

4. The package of claim 1, wherein said flexible support sleeve includes bends and flat portions, said flat portions contacting said scintillation element and said bends contacting said shield.

5. The package of claim 4, wherein said bends promote friction between said shield and said flexible support sleeve thereby suppressing relative movement between said shield and said flexible support sleeve.

6. The package of claim 4, further comprising a coating on said flat portions on a surface facing said scintillation element.

7. The package of claim 6, wherein said coating comprises a dry lubricant.

8. The package of claim 1, wherein said flexible support sleeve includes a gap.

9. A gamma detector, comprising:
a photomultiplier tube;
a first housing surrounding said photomultiplier tube; and
a flexible support sleeve supporting and at least partially surrounding said photomultiplier tube, wherein said flexible support sleeve touches and extends longitudinally along the length of said photomultiplier tube and wherein said flexible support sleeve is in spring compression between said photomultiplier tube and said first housing.

10. The gamma detector of claim 9, wherein said flexible support sleeve includes bends and flat portions, said flat portions contacting said photomultiplier tube and said bends contacting said first housing.

11. The gamma detector of claim 10, wherein said bends promote friction between said first housing and said flexible support sleeve thereby suppressing relative movement between said first housing and said flexible support sleeve.

12. The gamma detector of claim 9, further comprising an explosion-proof housing surrounding said first housing and a second flexible support sleeve positioned between said first housing and said explosion-proof housing.

13. The gamma detector of claim 12, further comprising a rigid enclosure surrounding said explosion-proof housing and a third flexible support sleeve positioned between said explosion-proof housing and said rigid enclosure.

14. A flexible support mechanism, comprising:
a rigid housing; and
a flexible support sleeve supporting and at least partially surrounding an object to be protected, wherein said flexible support sleeve touches and extends longitudinally along the length of said object and wherein said flexible support sleeve is in spring compression between said rigid housing and the object.

15. The mechanism of claim 14, wherein the object comprises a scintillation element, further including a shield positioned between said scintillation element and said flexible support sleeve.

16. The mechanism of claim 14, wherein the object comprises a scintillation element, further including a shield surrounding said flexible support sleeve.

17. The mechanism of claim 14, wherein the said flexible support sleeve is formed of a spring material.

18. The mechanism of claim 17, wherein said spring material comprises stainless steel.

19. The mechanism of claim 14, wherein said flexible support sleeve includes bends and flat portions, said flat portions contacting said object.

20. The mechanism of claim 19, wherein said bends of said flexible support sleeve promote friction between said object and said flexible support sleeve thereby suppressing relative movement between said object and said flexible support sleeve and dampening a resonant frequency of said flexible support sleeve.

21. The mechanism of claim 19, further comprising a coating on said flat portions on a surface facing said object.

22. The mechanism of claim 21, wherein said coating comprises a dry lubricant.

23. A flexible support mechanism, comprising:
an inner flexible support sleeve supporting and protecting an object to be protected;
an outer flexible support sleeve surrounding said inner flexible support sleeve and supporting said object, said outer flexible support sleeve fitting within a rigid housing; and
spacers spacing said inner flexible support sleeve from said outer flexible support sleeve;
wherein said flexible support sleeves extend longitudinally along the length of said object and are in spring compression between said object and said rigid housing.

24. The mechanism of claim 23, wherein the object comprises a scintillation element, further including a shield positioned between said scintillation element and said inner flexible support sleeve.

25. The mechanism of claim 23, wherein the object comprises a scintillation element, further including a shield positioned between said outer flexible support sleeve and a wall of said rigid housing.

26. The mechanism of claim 23, wherein said flexible support sleeves are formed of a spring material.

27. The mechanism of claim 26, wherein said spring material comprises stainless steel.

28. The mechanism of claim 23, wherein said flexible support sleeves include bends and flat portions, said flat portions contacting said object.

29. The mechanism of claim 28, wherein said bends of said inner flexible support sleeve promote friction between said object and said inner flexible support sleeve thereby suppressing relative movement between said object and said inner flexible support sleeve and dampening a resonant frequency of said inner flexible support sleeve.

30. The mechanism of claim 28, further comprising a coating on said flat portions on a surface facing said object.

31. The mechanism of claim 30, wherein said coating comprises a dry lubricant.

32. A gamma detector, comprising:
a scintillation element;
a first housing;
an inner flexible support sleeve supporting said scintillation element;
an outer flexible support sleeve supporting said scintillation element and surrounding said inner flexible support sleeve; and
spacers spacing apart said inner and outer flexible support sleeves;
wherein said outer flexible support sleeve fits within said first housing, wherein said flexible support sleeves are in spring compression between said scintillation element and said rigid housing and wherein said flexible support sleeves extend longitudinally along the length of said scintillation element.

33. The gamma detector of claim 32, further comprising a photomultiplier tube.

34. The gamma detector of claim 33, further comprising an explosion-proof housing encasing said photomultiplier tube.

35. The gamma detector of claim 32, wherein said first housing includes at least one window allowing said scintillation element to be exposed to gamma radiation.

36. The gamma detector of claim 35, wherein said first housing comprises an armor material positioned to protect said gamma detector from flying debris.

37. The gamma detector of claim 36, further comprising a shield encompassing said scintillation element.

38. The gamma detector of claim 37, further comprising a rigid dynamic enclosure surrounding said shield and including an opening to allow gamma rays to enter said enclosure.
